(19) United States
(12) Patent Application Publication
(10) Pub. No.: US 2025/0217879 A1
(43) Pub. Date: Jul. 3, 2025

(54) Decentralized Global Banking System (DGBS)

(71) Applicant: FURONG BEI, San Gabriel, CA (US)

(72) Inventor: FURONG BEI, San Gabriel, CA (US)

(21) Appl. No.: 19/084,806

(22) Filed: Mar. 20, 2025

(51) Int. Cl. G06Q 40/02; G06Q 20/02; G06Q 20/38; G06Q 20/40; G06Q 40/03; G06Q 40/06; G06Q 40/08; G06Q 50/16; G07F 19/00; H04L 9/08

(52) U.S. Cl. CPC G06Q 40/02; G06Q 20/027; G06Q 20/389; G06Q 20/4014; G06Q 40/03; G06Q 40/06; G06Q 40/08; G06Q 50/16; G07F 19/211; H04L 9/0852; G06Q 2220/00

(57) ABSTRACT

The Decentralized Global Banking System (DGBS) introduces a borderless, AI-enhanced, blockchain-powered financial infrastructure that eliminates reliance on traditional banks, credit bureaus, and centralized institutions. It enables global individuals and entities to access financial services autonomously, ensuring universal financial inclusion, efficiency, and security through decentralized credit scoring, AI-driven risk assessment, P2P lending, decentralized automated teller machines, and smart contract-driven financial solutions.

### TECHNICAL FIELD

This invention relates to decentralized financial systems, specifically a global banking infrastructure that operates without reliance on traditional banking institutions. It integrates artificial intelligence (AI), blockchain technology, and distributed financial mechanisms to enable financial inclusivity and seamless global transactions.

### BACKGROUND OF THE INVENTION

The current global banking system is centralized, exclusive, and limited by geographical and regulatory constraints. Many individuals and businesses are unbanked or underbanked due to lack of credit history, high fees, or political instability. Existing financial infrastructures are slow, costly, and vulnerable to systemic risks. A decentralized global banking system (DGBS) eliminates these limitations by providing financial services that are universally accessible, self-regulating, and trustless.

### SUMMARY OF THE INVENTION

The Decentralized Global Banking System (DGBS) revolutionizes global finance through:
AI-driven decentralized credit scoring (removes reliance on centralized banks and credit bureaus).
Peer-to-peer (P2P) global lending and borrowing.
Decentralized Automated Teller Machines (ATMS.com integrated with USDAO/USDAL system).
Smart contract-driven financial agreements, reducing third-party dependency.
Self-sovereign digital identity (no reliance on government-issued documents).
Cryptographic asset management with AI-enhanced risk mitigation.
Decentralized insurance and wealth management solutions.
Interoperability across national and digital economies.

### DETAILED DESCRIPTION OF THE INVENTION

### Decentralized Credit Scoring System:

AI-driven algorithm that evaluates creditworthiness based on blockchain-verified financial activity, transaction history, and socio-economic behavior.
Eliminates dependency on credit bureaus.

### P2P Global Lending System:

Smart contracts facilitate borderless loans.
No intermediary financial institutions required.
Decentralized dispute resolution mechanisms for lending agreements.

### Global Automated Teller Machine (ATMS.Com+USDAO Integration):

Provides borderless financial access to fiat and digital assets.
Withdrawals, deposits, and currency swaps enabled via decentralized finance (DeFi).

### Decentralized AI-Powered Banking Platform:

Self-regulating financial ecosystems using AI-based fraud detection and risk assessment.
Eliminates the need for traditional banking infrastructure.

### Universal Digital Identity System:

Blockchain-based identity verification, allowing financial participation without traditional identification documents.
Enhanced privacy and security features.

### Cryptographic Asset Management:

AI-powered robo-advisors optimize wealth portfolios.
Decentralized storage ensures security and ownership.

### Decentralized Insurance & Risk Management:

Smart contract-driven insurance policies with AI-driven claims verification.
Fraud-proof and censorship-resistant.

### Interoperability Across Economies:

Seamless integration with existing financial systems and digital economies.
Enables cross-border transactions without friction.

### BRIEF DESCRIPTION OF THE DRAWINGS

Diagram illustrating the decentralized credit scoring algorithm.
Flowchart of the P2P lending system.
Architecture of the ATMS.com+USDAO ecosystem.
Blockchain-based universal digital identity system.
AI-powered fraud detection and risk mitigation system.

1. A decentralized credit scoring system utilizing AI and blockchain to assess financial credibility without a centralized authority.

2. A global peer-to-peer lending framework utilizing smart contracts for risk-free borderless transactions.

3. A decentralized automated teller machine network (ATMS.com+USDAO) for fiat and digital asset transactions.

4. A digital identity verification system that eliminates reliance on government-issued documents.

5. A cryptographic wealth management system that integrates AI-driven investment strategies.

6. A decentralized insurance system utilizing smart contracts for fraud-resistant claims processing.

7. An AI-powered decentralized banking system providing autonomous financial services.

8. A decentralized dispute resolution mechanism for financial transactions.

9. A self-regulating AI-driven fraud detection and risk assessment framework.

10. A global blockchain-based currency exchange facilitating seamless cross-border transactions.

11. A quantum-secure cryptographic infrastructure for financial data protection.

12. A multi-layered authentication system ensuring decentralized financial security.

13. A universal asset tokenization framework integrating physical and digital assets.

14. A smart contract-based inheritance and trust fund management system.

15. A decentralized real estate and property transaction platform.

16. A decentralized hedge fund and asset pooling mechanism.

17. A cross-chain decentralized payment gateway supporting multiple currencies.

18. A blockchain-driven payroll and compensation system eliminating banking intermediaries.

19. A distributed liquidity pool management system optimizing global financial stability.

20. A decentralized public finance and taxation infrastructure integrating smart governance principles.
